(19) United States
(12) Patent Application Publication
(10) Pub. No.: US 2026/0036930 A1
(43) Pub. Date: Feb. 5, 2026

(54) IMAGE FORMING APPARATUS, PARAMETER ADJUSTMENT METHOD, AND COMPUTER-READABLE RECORDING MEDIUM STORING CONTROL PROGRAM

(71) Applicant: KONICA MINOLTA, INC., Tokyo (JP)

(72) Inventors: Yuta Tachibana, Toyokawa-shi (JP); Kazumichi Yoshida, Tokyo (JP); Kouei Cho, Toyohashi-shi (JP); Satoshi Miyajima, Tokyo (JP); Kei Kiyama, Kawasaki-shi (JP); Akimasa Ishikawa, Tokyo (JP)

(73) Assignee: KONICA MINOLTA, INC., Tokyo (JP)

(21) Appl. No.: 19/283,625

(22) Filed: Jul. 29, 2025

(30) Foreign Application Priority Data
Aug. 1, 2024 (JP) 2024-125642

(51) Int. Cl. G03G 15/20; G03G 15/00

(52) U.S. Cl. CPC G03G 15/205; G03G 15/2064; G03G 15/657; G03G 15/6585; G03G 2215/00413; G03G 2215/00772; G03G 2215/0081

(57) ABSTRACT

An image forming apparatus includes: a fixer that fixes a toner image on a sheet; and a controller that sets a target glossiness, and adjusts at least one parameter selected from a fixing target temperature and a conveyance condition of the sheet in the fixer, using a gloss control temperature, to achieve the target glossiness that has been set.

### CROSS-REFERENCE TO RELATED APPLICATION

The entire disclosure of Japanese patent application No. 2024-125642, filed on Aug. 1, 2024, is incorporated herein by reference in its entirety.

### BACKGROUND OF THE INVENTION

### 1. Technical Field

The present invention relates to an image forming apparatus, a parameter adjustment method, and a computer-readable recording medium storing a control program.

### 2. Description of Related art

There is a demand for a fixing device that can stably fix a high-quality image onto a sheet. Furthermore, in addition to high quality, recent fixing devices are also required to be able to realize a wider range of glossiness from a low glossiness suitable for plain paper to a high glossiness suitable for photographic images. In general, in an electrophotographic image forming apparatus, a sheet on which a toner image is formed by an image former is passed through a fixing nip portion formed by a fixing member such as a roller. Then, the toner image is fixed onto the sheet by heating and pressing.

In an image forming apparatus, it is known that the glossiness of a formed image generally changes depending on a combination of a plurality of parameters such as a fixing temperature, a conveyance speed, and a nip width. For example, Japanese Patent No. 5557613 discloses an apparatus that includes a fixing mechanism and a gloss sensor. In this apparatus, the temperature of the fixing mechanism is changed in a plurality of stages, and the glossiness at that time is measured, so that a gloss versus temperature curve indicating the relationship between the glossiness and the temperature of the fixing mechanism is obtained in advance. The temperature of the fixing mechanism is then set using the gloss versus temperature curve in response to an instruction by a user about a desired glossiness.

On the other hand, the parameters such as the fixing temperature, the conveyance speed, and the nip width may be adjusted for purposes other than the purpose of glossiness adjustment. For example, the parameters are adjusted for the purpose of changing image quality other than the glossiness according to an instruction by a user such as an operator or a service person, and are adjusted automatically due to another factor by a controller. In this case, the glossiness may unintentionally change due to the adjustment of these parameters. Alternatively, the glossiness may change due to an elapsed time from power-on of an image forming apparatus main body, temperature saturation of a fixing device due to continuous printing, or the like.

In such a case, there has been a problem that a user has to perform work such as readjusting the glossiness again, and sheets are wastefully consumed for the adjustment.

### SUMMARY OF THE INVENTION

The present invention has been made in consideration of the above-described circumstances, and an object thereof is to provide an image forming apparatus and a parameter adjustment method capable of maintaining a desired glossiness.

To achieve at least one of the abovementioned objects, according to an aspect of the present invention, a device reflecting one aspect of the present inventions comprises the followings.

An image forming apparatus including:
a fixer that fixes a toner image on a sheet; and
a controller that:
   sets a target glossiness; and
   adjusts at least one parameter selected from a fixing target temperature and a conveyance condition of the sheet in the fixer, using a gloss control temperature, to achieve the target glossiness that has been set.

### BRIEF DESCRIPTION OF THE DRAWINGS

Advantages and features provided by one or more embodiments of the present invention will be fully understood in conjunction with the following detailed description and the accompanying drawings. It should be however understood that these embodiments are merely illustrative and are not intended to limit the present invention.

FIG. 1 is a diagram illustrating a schematic configuration of an image forming apparatus according to the present embodiment;

FIG. 2 is a block diagram illustrating a configuration of the image forming apparatus;

FIG. 3A is an example of a glossiness-nip width graph;

FIG. 3B is an example of a glossiness-conveyance speed graph;

FIG. 3C is an example of a glossiness-fixing temperature graph;

FIG. 4A is an example of a glossiness-combined parameter graph for paper type A;

FIG. 4B is an example of a glossiness-combined parameter graph in which a gloss control temperature is applied as a combined parameter for paper type A;

FIG. 5A is an example of a glossiness-combined parameter graph for paper type B;

FIG. 5B is an example of a glossiness-combined parameter graph in which a gloss control temperature is applied as a combined parameter for paper type B;

FIG. 6A is an example of a glossiness-combined parameter graph for paper type C;

FIG. 6B is an example of a glossiness-combined parameter graph in which a gloss control temperature is applied as a combined parameter for paper type C;

FIG. 7 is an example of a glossiness estimation model to which a linear function is applied;

FIG. 8A is an example of a glossiness estimation model to which a sigmoid function for paper type A is applied;

FIG. 8B is an example of a glossiness estimation model to which a sigmoid function for paper type B is applied;

FIG. 8C is an example of a glossiness estimation model to which a sigmoid function for paper type C is applied;

FIG. 9 is a flowchart illustrating parameter adjustment processing;

FIG. 10 is a subroutine flowchart illustrating gloss control constant calculation processing in step S02 of FIG. 9;

FIG. 11A is an example of a setting screen for a glossiness target value;

FIG. 11B is a diagram illustrating a procedure for setting a glossiness target value from a glossiness control constant.

FIG. 12 is a subroutine flowchart illustrating target glossiness setting processing in step S02 of FIG. 9 according to another example;

FIG. 13 is a subroutine flowchart illustrating target glossiness setting processing in step S02 of FIG. 9 according to another example;

FIG. 14 is a diagram illustrating a procedure for setting a glossiness control constant from a glossiness target value;

FIG. 15 is a flowchart illustrating parameter adjustment processing in step S08 of FIG. 9;

FIG. 16 is a flowchart illustrating the parameter adjustment processing in step S08 of FIG.

9;

FIG. 17 is a flowchart illustrating processing performed when a paper type is changed in one print job according to Modification Example 1; and

FIG. 18 is a flowchart illustrating processing performed when a user adjusts parameters according to Modification Example 2.

### DETAILED DESCRIPTION

In the following, embodiments of the present invention will be described with reference to the accompanying drawings. Note that in the description of the drawings, the same components are denoted by the same reference sign, and redundant descriptions are omitted. In addition, dimensional ratios in the drawings are exaggerated for convenience of the description and may be different from actual ratios. In the present embodiment, examples of a sheet include sheets produced using plant-derived mechanical pulp and/or chemical pulp. Examples of the type of the sheet (paper type) include gloss paper and matte paper which are coated paper, plain paper and high-quality paper which are uncoated paper, and the like.

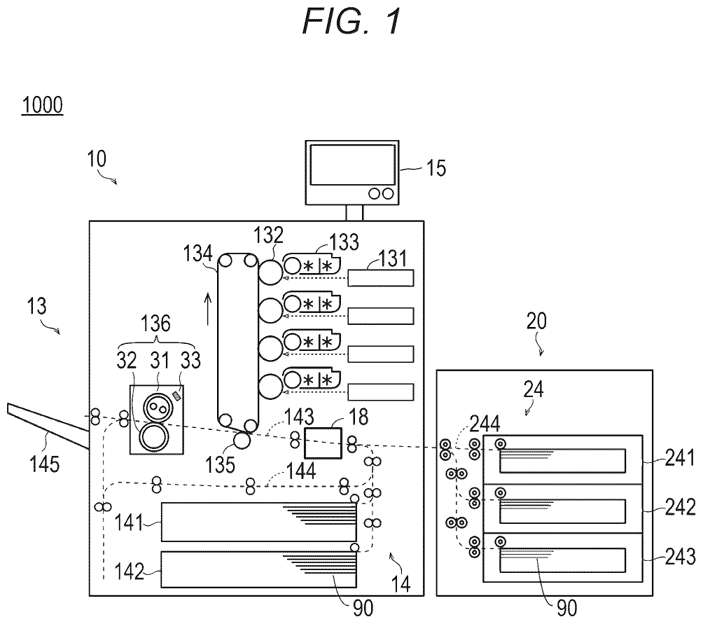

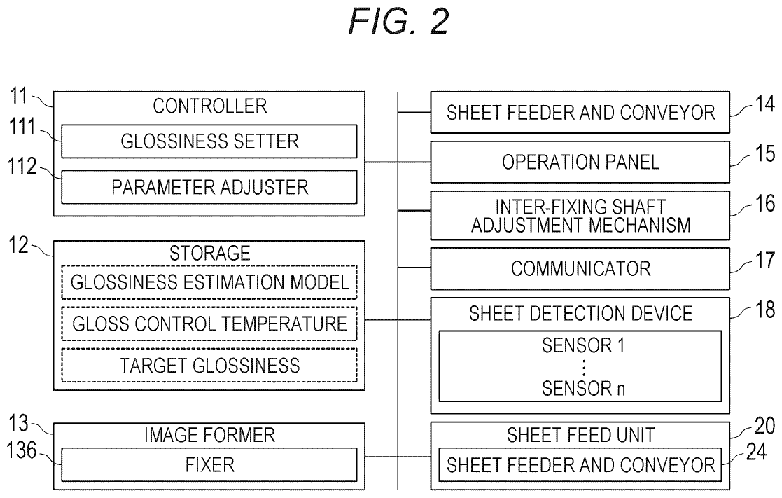

FIG. 1 is a diagram illustrating a schematic configuration of an image forming apparatus 1000 according to the present embodiment. As illustrated in FIG. 1, the image forming apparatus 1000 includes an image forming apparatus main body 10 and a sheet feed unit 20 that are mechanically and electrically communicably connected to each other.

### Image Forming Apparatus Main Body 10

The image forming apparatus main body 10 includes a controller 11, a storage 12, an image former (or image forming device) 13, a sheet feeder and conveyor 14, an operation panel 15, an inter-fixing shaft adjustment mechanism 16, a communicator (or communication interface) 17, a sheet detection device 18, and the like. These components are connected to each other via a signal line such as a bus for exchanging signals.

### Controller 11

The controller 11 includes a CPU, a ROM, a RAM, and the like. The controller 11 executes various kinds of processing by executing programs stored in the ROM and the storage 12 which will be described below, and controls various components of the apparatus and performs various kinds of arithmetic processing in accordance with the programs. The controller 11 functions as a glossiness setter 111 and a parameter adjuster 112.

### Glossiness Setter 111

The glossiness setter 111 sets a target glossiness. The target glossiness is set as follows.
(1a) The glossiness setter 111 receives a relative value of a desired glossiness input by a user through the operation panel 15.
(2a) The glossiness setter 111 receives an absolute value of the desired glossiness input by the user through the operation panel 15.
(3a) In forming an image for one print job, the glossiness setter 111 sets an initial glossiness as the target glossiness so as to make the glossiness constant in the print job. In this case, the initial glossiness is estimated at the beginning of the print job (for example, one to several sheets), and this glossiness is set as the target glossiness. In the case of (3a), the target glossiness is maintained in order to suppress the glossiness from fluctuating due to an elapsed time from the power ON of the image forming apparatus main body or a temperature saturation of the fixing device by continuous printing, in the same print job. The target glossiness set by the glossiness setter 111 is stored in the storage 12.

### Parameter Adjuster 112

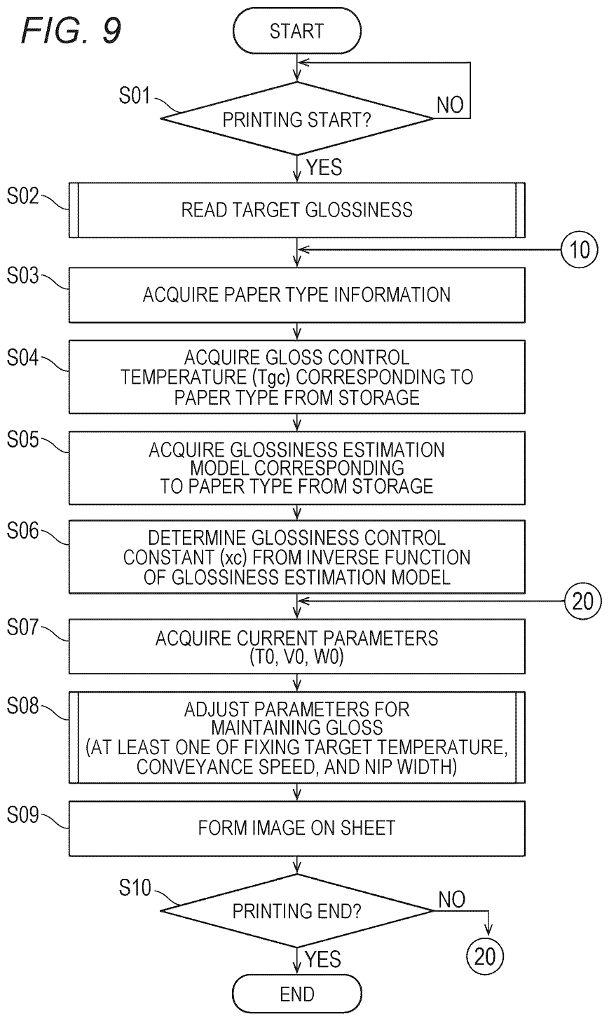

By processing described below (FIG. 9 and the like), the parameter adjuster 112 adjusts parameters for image formation so as to achieve the target glossiness as the glossiness. For the adjustment of the parameter, a difference (T−Tgc) between a fixing temperature and a gloss control temperature is used (Formulas (1), (5), (6), and the like described below). The parameters include a fixing target temperature (which corresponds to a target value of a fixing control temperature and is also referred to as a fixing target temperature Tt) and/or a conveyance condition. The conveyance condition includes a conveyance speed of a sheet and a fixing nip width (hereinafter, also simply referred to as a nip width). As the selection of the parameters to be adjusted, a priority may be set in advance, and three parameters may be selected according to the priority. For example, the fixing target temperature, the nip width, and the conveyance speed are prioritized in this order. With regard to each parameter, furthermore, an adjustment range width is set. When each parameter reaches the upper limit or the lower limit of the adjustment range width, the parameter with the next priority is selected. For example, in increasing the glossiness, in the parameter adjustment, the fixing target temperature is selected first and, when the fixing target temperature reaches the upper limit of the adjustment range, the nip width is selected next and is adjusted to be widened. In addition, when the nip width also reaches the upper limit of the adjustment range, the conveyance speed is selected next and is adjusted to be reduced. In a case where the parameters are adjusted during execution of a print job, print job standby processing may be performed until the parameters are changed. For example, this standby processing includes temporarily stopping conveyance driving or increasing a sheet interval without stopping the conveyance driving.

### Storage 12

The storage 12 includes a ROM that stores various programs and various types of data in advance, a RAM that temporarily stores programs and data as a work area, and an auxiliary storage such as a hard disk that stores various programs and various types of data.

In addition, the storage 12 stores information on sheets stored in each sheet feed tray. The sheet information includes information on a brand, a size (a sheet width, a sheet length), a basis weight (a ream weight), and a paper type (coated paper, plain paper, high-quality paper, rough paper, etc.) of the sheets, and is set by paper type determination processing described below. Furthermore, the storage 12 may store a trained model used for determination of a brand or a type of the sheets, and a paper profile (both of which will be described below).

The storage 12 also stores a glossiness estimation model, a gloss control temperature (Tgc), and a target glossiness. The glossiness estimation model and the gloss control temperature are set for each paper type and stored in association with the paper type. Further, the target glossiness is stored in association with any one of the paper type, the print job, and the entire apparatus.

The glossiness estimation model is a function describing the relationship between a glossiness control constant x and a glossiness. As the function, a polynomial function or a sigmoid function can be applied. The gloss control temperature (Tgc) is a factor in the glossiness control constant x. The target glossiness to be stored includes a target glossiness commonly applied in the image forming apparatus 1000, a target glossiness for each paper type, and a target glossiness for each print job. Details of the glossiness estimation model and the gloss control temperature will be described below.

### Image Former 13

The image former 13 forms an image by, for example, an electrophotographic method. As illustrated in FIG. 1, the image former 13 includes writing/exposing parts 131, photosensitive drums 132, developing devices 133, and the like corresponding to basic colors of Y (yellow), M (magenta), C (cyan), and K (black). Each of the developing devices 133 accommodates a two-component developer made of toner and a carrier of the corresponding color. Furthermore, the image former 13 further includes an intermediate transfer belt 134, a secondary transferer 135, and a fixer 136. The toner images formed on the photosensitive drums 132 by the developing devices 133 for the respective colors are superimposed on each other on the intermediate transfer belt 134 and transferred to a sheet 90 conveyed by the secondary transferer 135. The toner images on the sheet 90 are heated and pressed by the fixer 136 on the downstream side and thus fixed onto the sheet 90.

The image former 13 includes the fixer 136 as described above.

The fixer 136 includes a heating roller 31 and a pressure roller 32 as fixing members, and applies pressure and heat to the sheet 90 conveyed by a fixing nip between the heating roller 31 and the pressure roller 32 to melt and fix the toner image onto the surface of the sheet 90.

The heating roller 31 includes, in order from an inner side, a cored bar made of a cylindrical metal, an elastic layer made of a material such as silicone rubber or foamed silicone rubber and formed on a surface of the cored bar, and a release layer made of a fluorine resin or the like. Inside the cored bar, heaters of a plurality of halogen lamps are arranged. The length of the heating roller 31 in a rotation axis direction (hereinafter, simply referred to as a “width direction”) orthogonal to a conveyance direction of the sheet 90 is long enough to fix the image on the sheet 90 having the maximum width that can be conveyed. The plurality of heaters 2 may be heaters having different heat distribution (light distribution characteristics) corresponding to multilevel sheet widths feedable by the apparatus.

The pressure roller 32 includes, in order from an inner side, a cored bar made of a cylindrical metal, an elastic layer made of a material such as silicone rubber or foamed silicone rubber and formed on a surface of the cored bar, and a release layer made of a fluorine resin or the like. The outer diameter and the axial length of the pressure roller 32 are substantially equal to those of the heating roller 31. Note that a heater may also be disposed inside the cored bar of the pressure roller 32.

A temperature sensor 33 detects a temperature of the surface of the heating roller 31. A plurality of temperature sensors 33 may be arranged. For example, the temperature sensors 33 are arranged at different positions in the width direction, such as a central portion, a far side, and a near side, and measure the temperature distribution of the heating roller 31 in the width direction. As the temperature sensor 33, for example, a thermistor arranged in a non-contact manner with respect to the heating roller 31 is used.

### Sheet Feeder and Conveyor 14

The sheet feeder and conveyor 14 includes a plurality of sheet feed trays 141 and 142, conveyance paths 143 and 144, and the like. The conveyance paths 143 and 144 include a plurality of conveyance roller pairs provided along these conveyance paths and drive motors (not illustrated) that drive these conveyance roller pairs. The sheet feeder and conveyor 14 includes a delivery roller that delivers the uppermost one of the plurality of sheets 90 loaded and placed in the sheet feed trays 141 and 142, and delivers the sheets 90 in the sheet feed trays one by one to the conveyance path on the downstream side. On the upstream side of registration rollers (a pair of rollers immediately upstream of the secondary transferer 135) on the conveyance path 143, the sheet detection device 18 is disposed.

The sheet feeder and conveyor 14 conveys the sheet 90 fed from the sheet feed tray 141 or the like. The sheet 90 conveyed through the conveyance path 143 is ejected onto a sheet ejection tray 145 after an image is formed on the sheet 90 by the image former 13. In double-sided printing in which an image is also formed on a back surface of the sheet 90, the sheet feeder and conveyor 14 conveys the sheet 90 having an image formed on one side to a conveyance path 144 for double-sided image formation in a lower portion of the apparatus main body. The sheet 90 conveyed to the conveyance path 144 is turned upside down by a switchback path and then conveyed to the conveyance path 143 for single-sided printing, and an image is again formed on the other side of the sheet 90 in the image former 13.

### Operation Panel 15

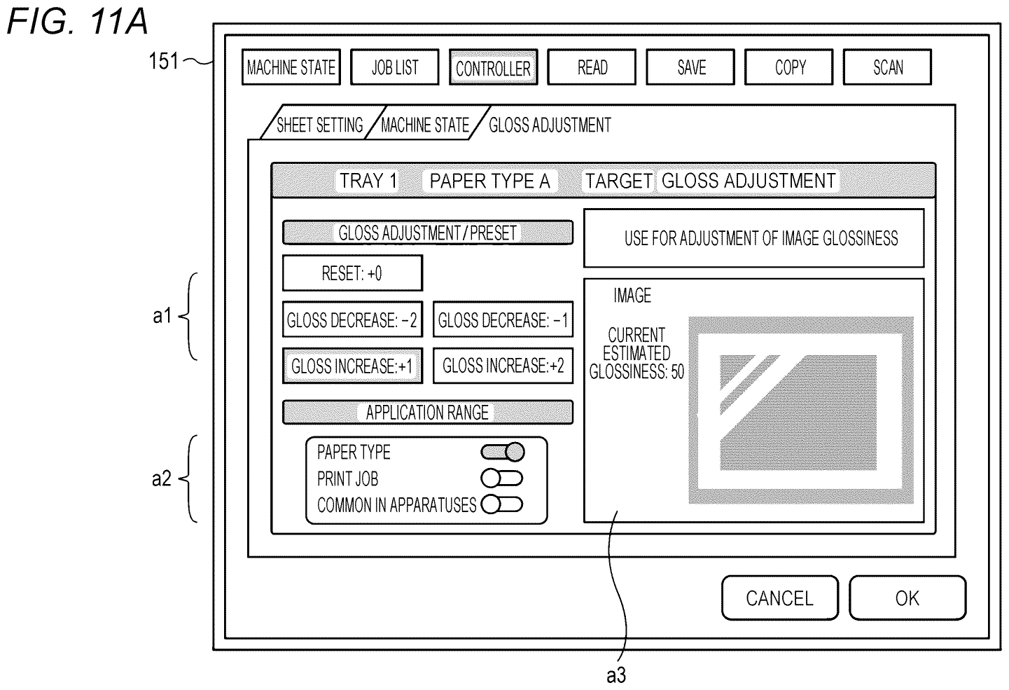

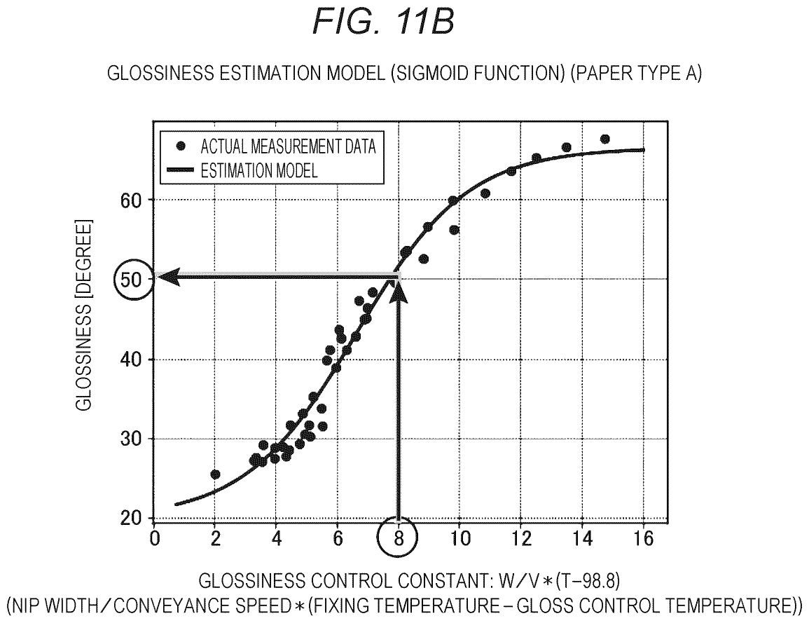

The operation panel 15 includes a touch screen, a numeric keypad, a start button, a stop button, and the like. The operation panel 15 displays a state of the image forming apparatus main body 10 or the image forming apparatus 1000, life information (replacement timing) of the rollers, and the like, and is used for input of settings and instructions by the user, such as the type of sheet placed in the sheet feed tray 141 or the like. In addition, the user can set a desired glossiness with the operation panel 15 (FIG. 11A described below).

### Inter-Fixing Shaft Adjustment Mechanism 16

The inter-fixing shaft adjustment mechanism 16 moves a shaft of one of two fixing members to adjust the nip width. For example, the inter-fixing shaft adjustment mechanism 16 supports both sides of the rotation shaft of the pressure roller 32. Next, the inter-fixing shaft adjustment mechanism 16 changes a distance between the shaft of the heating roller 31 and the shaft of the pressure roller 32 by moving up and down the rotation shaft of the pressure roller 32 toward the shaft of the heating roller 31 opposite the pressure roller 32. The inter-fixing shaft adjustment mechanism 16 includes a cam mechanism and a drive source such as a motor. The controller 11 includes a control table in which a correspondence relation among the driving amount of the inter-fixing shaft adjustment mechanism 16, the shaft height of the pressure roller 32, and the nip width is described, and controls the driving amount of the inter-fixing shaft adjustment mechanism 16 so as to achieve the set nip width.

### Communicator 17

The communicator 17 includes an interface circuit for communicating with an external device via a network.

### Sheet Detection Device 18

The sheet detection device 18 includes a plurality of sensors 1 to n and detects physical property values of the sheet 90 conveyed on the conveyance path 143. The sensors include sensors for detecting a sheet thickness, a basis weight, a moisture content, a stiffness, a surface property, and a sheet resistance (electrical resistance).

The “sheet thickness” is acquired by the sensor 1 detecting a characteristic corresponding to the thickness of a sheet. The sensor 1 measures a distance between two members between which the sheet is sandwiched.

The “basis weight” is acquired by the sensor 2 detecting a characteristic corresponding to the basis weight of the sheet. The sensor 2 is, for example, a transmission-type and reflection- type optical sensor. The sensor 2 acquires the basis weight by measuring an attenuation amount (transmittance) of light transmitted through the sheet.

The “moisture content” is acquired by the sensor 3 detecting a characteristic corresponding to the moisture content (also referred to as water content) of the sheet. The sensor 3 optically detects, for example, a light absorption amount of an OH group of a near-infrared method, using the light transmitted through the sheet.

The “stiffness” is acquired by the sensor 4 detecting a characteristic corresponding to the stiffness of the sheet. The sensor 4 measures a pressing force applied to a rear end of the sheet as a free end. The “stiffness” indicates a value related to a sheet bending strength.

The “surface property” is acquired by the sensor 5 detecting a characteristic corresponding to the smoothness of the surface property of the sheet. The “surface property” is also referred to as the smoothness. The sensor 5 includes an irradiator and light receivers. For example, the sensor 5 irradiates the surface of the sheet with light at an incident angle of 75 degrees, and optically detects specular reflection light and diffuse reflection light from the surface of the sheet by two sensors. The “surface property” indicates a value related to a sheet surface condition.

The “sheet resistance” is acquired by the sensor 6 detecting a characteristic corresponding to the electrical resistance of the inside or the surface of the sheet. The sensor 6 measures a voltage and a flowing current when a high voltage is applied to the sheet. The “sheet resistance” indicates a value related to a sheet volume resistance.

### Paper Type or Paper Brand Determination Processing

The paper type or paper brand of the sheet 90 stored in the sheet feed tray is set by the user through the operation panel 15. Alternatively, the stored sheet 90 is detected by the sheet detection device 18 as described below, and the paper type or the paper brand is determined based on the detection data.

### Paper Type Determination Processing

A sheet 90 is conveyed from a target sheet feed tray, and sheet physical properties (also referred to as sheet characteristics) are measured by the sheet detection device 18. The sheet physical properties to be measured include those obtained by the above-described sensors. For example, the controller 11 performs a paper type determination and a basis weight category measurement based on the obtained plurality of sheet physical properties, such as a basis weight, a sheet thickness, and a surface property. These determinations may be performed on a rule basis to determine the paper type and the basis weight category, using a trained model (paper type determination engine) and a paper profile. Here, the “paper profile” is previously registered for a certain sheet in association with a measurement value of the sheet detection device 18 as well as characteristic data, a sheet size, an arbitrary identification name (e.g., a paper brand), and the like input from the user. The paper brand is obtained by identifying the brand of a paper manufacturer and further subdividing the paper type, and when the paper brand is identified, the paper type is identified. The “paper type determination engine” is also referred to as a trained model, and is a trained model generated by supervised learning using training data with a detection output of the sheet 90 by the sheet detection device 18 as an input value, and with the paper type information of the sheet 90 set by the user as a label or correct data. After the paper type determination and the basis weight category determination are performed by the controller 11, determination results are displayed on the operation panel 15. When the user confirms the determination results (with a confirmation button), the determination results are fixed, and the information on the sheet feed tray and the information on the paper type are stored in the storage 12 in association with each other. In the paper type determination processing, upon detecting that there is no paper type (paper brand) having the same sheet physical properties, the controller 11 identifies whether or not there is data having similar sheet physical properties, by using the paper profile of the storage 12. The parameter adjuster 112 derives the gloss control temperature Tgc and the glossiness estimation model for the target sheet, using the gloss control temperature Tgc and the glossiness estimation model associated with the paper type (paper brand) having one of or a plurality of the similar sheet physical properties. For example, if there are two gloss control temperatures Tgc and two glossiness estimation models having similar sheet physical properties, the gloss control temperature Tgc and the glossiness estimation model of the target sheet are derived by interpolation or extrapolation according to the Euclidean distance from the sheet physical properties.

### Sheet Feed Unit 20

As illustrated in FIG. 1, the sheet feed unit 20 includes a sheet feeder and conveyor 24. Furthermore, the sheet feed unit 20 includes, in addition to the sheet feeder and conveyor 24, a controller, a storage, and a communicator (or communication interface) none of which are illustrated and which are connected to each other via a signal line such as a bus for exchanging signals. The communicator communicates with the image forming apparatus main body 10. The sheet feeder and conveyor 24 includes a plurality of sheet feed trays 241, 242, and 243, and a conveyance path 244. A sheet 90 conveyed from each of the sheet feed trays is conveyed to the image forming apparatus main body 10 on the downstream side, and the sheet characteristics are measured by the sheet detection device 18 or an image is formed by the image former 13.

### Glossiness Estimation Model, Gloss Control Temperature

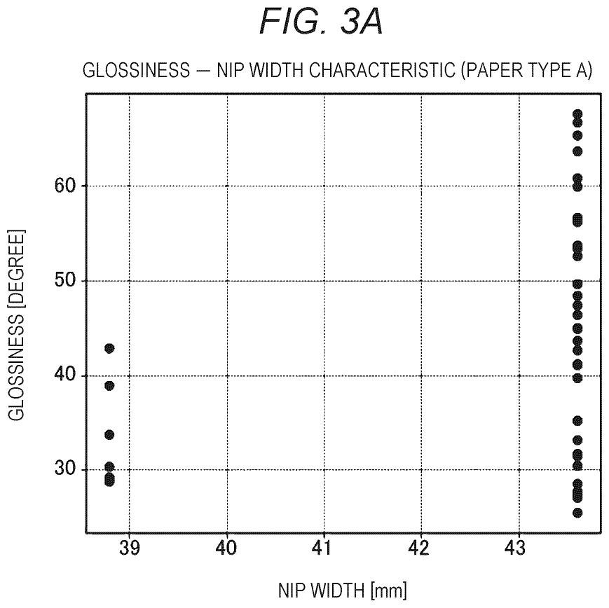

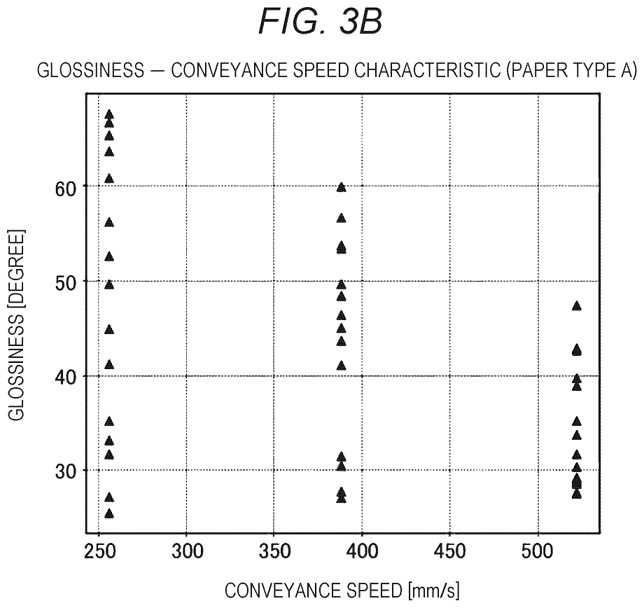

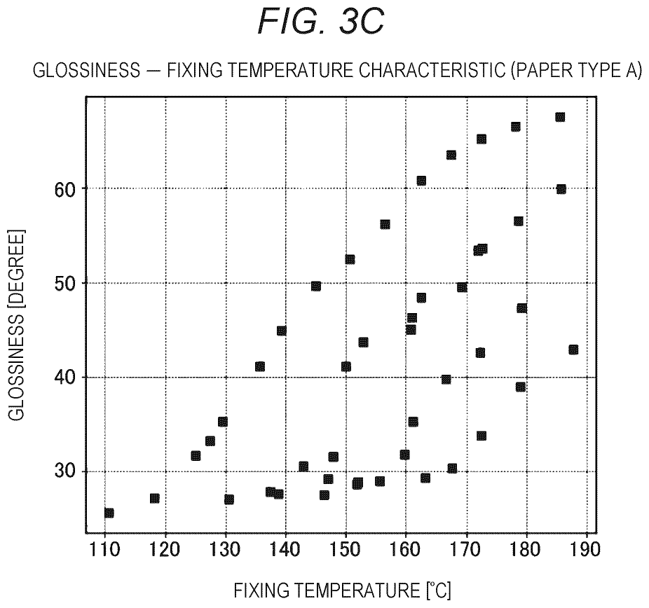

Next, the glossiness estimation model and the gloss control temperature Tgc will be described with reference to FIGS. 3A to 8C. Here, the gloss is expressed by a glossiness. The glossiness used in the present embodiment was a specular glossiness at an angle of 60° measured by a method defined in the JIS standard (JIS Z8741). A value is used as the used glossiness, in which a reflectance of 10% at an incident angle of 60° on a glass surface having a refractive index of 1.567 is defined as a glossiness of 100 (%). A glossmeter (GM-60A) manufactured by Konica Minolta Co., Ltd. was used for measuring the glossiness.

The gloss on a sheet is controlled by a fixing temperature, a nip width, and a nip time. Here, the fixing temperature refers to an actually measured temperature (which is actually measured by the temperature sensor 33) of the surface of the heating roller 31 in fixing a sheet. As a related term, there is a fixing target temperature. The fixing target temperature is a control temperature for the heating roller 31. The controller 11 controls power supply to the heater that heats the fixer 136 so that the actual measurement value of the temperature sensor 33 becomes equal to the fixing target temperature. As described above, the nip width is the length of the nip formed between the heating roller 31 and the pressure roller 32 in the conveying direction. The nip width is variably adjusted by the inter-fixing shaft adjustment mechanism 16.

The nip time is a time for which the sheet passes through the nip. Under the condition that the nip width is constant, the nip time is inversely proportional to the conveyance speed of a sheet. The conveyance speed is also referred to as a system speed and is commonly applied in the entire image forming apparatus main body 10. The conveyance speed is made variable by controlling the rotation speed of a drive motor (not illustrated). Note that as the conveyance speed, only the conveyance speed of the fixer 136 may be changed. If the speed difference between the system speed and the conveyance speed of the fixer 136 is within a predetermined range (e.g., within a range of several percents), the speed difference can be absorbed by the slack of a sheet.

FIGS. 3A to 3C are scatter plot graphs illustrating the influence of control factors (hereinafter, referred to as parameters) of a nip width, a conveyance speed, and a fixing temperature relative to a glossiness in the case of specific paper type A. However, as illustrated in FIGS. 3A to 3C, the relationship between the glossiness and the parameters is not observed for each parameter.

Therefore, on the assumption that the glossiness has a correlation with the amount of heat applied to the toner, the following assumptions were made and the parameters were combined.
(1b) As the nip width is wide, the heating time increases, and the glossiness therefore increases. That is, the glossiness is proportional to the nip width.
(2b) As the conveyance speed is low, the fixing passage time increases, and the glossiness increases. That is, the glossiness is inversely proportional to the conveyance speed.
(3b) As the fixing temperature is high, the glossiness increases.
(4b) However, a fixing temperature more than a certain temperature (hereinafter, referred to as a gloss control temperature or a gloss control temperature Tgc), which is influenced by the fixing temperature but is not simply proportional to the fixing temperature, is proportional to the glossiness.

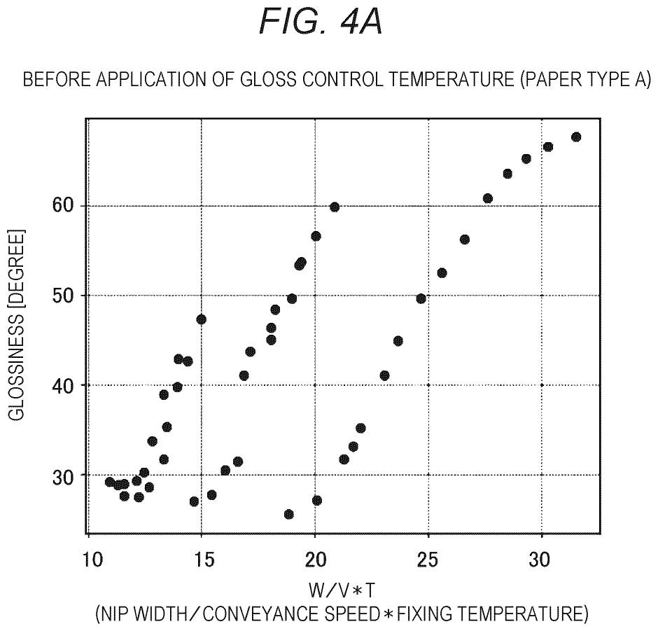

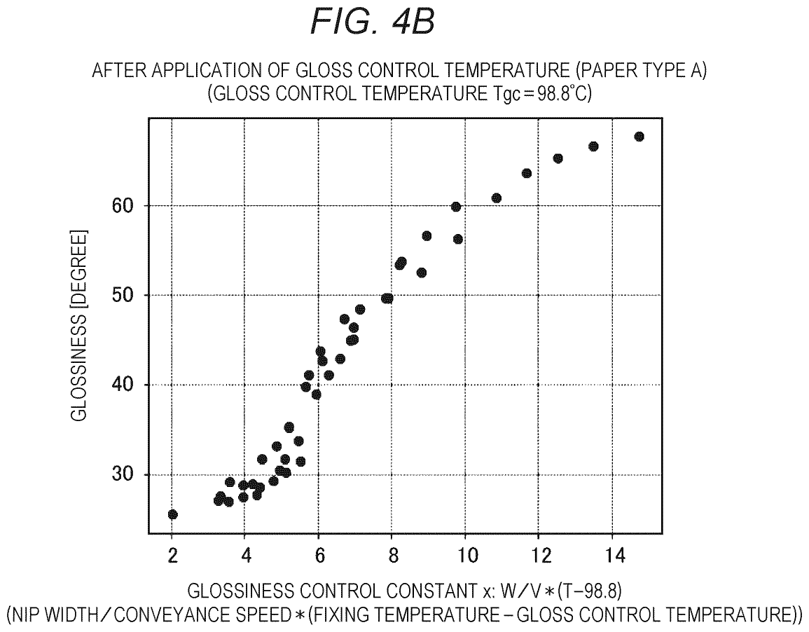

FIGS. 4A and 4B are examples of a glossiness-combined parameter scatter plot graph for paper type A. In FIG. 4A, the parameters are combined under the assumptions (1b) to (3b) described above. In FIG. 4B, the parameters are combined under the assumptions (1b) to (3b) as well as the assumption (4b). That is, in FIG. 4A, the horizontal axis represents “nip width/speed *fixing temperature”, and in FIG. 4B, the horizontal axis represents “nip width/speed*(fixing temperature-gloss control temperature)”. The letter*indicates multiplication. The same applies hereinafter. In the graphs of FIGS. 4A and 4B and the following description, the nip width may be denoted by W, the conveyance speed may be denoted by V, and the fixing temperature may be denoted by T. In addition, hereinafter, the combined parameter (nip width/speed * (fixing temperature−gloss control temperature)), which is obtained on the assumptions (1b) to (4b), is particularly referred to as a “gloss control constant” or a “gloss control constant x0”. That is, the gloss control constant is defined by Formula (1) below.

$$\begin{matrix}[ Mathematical Formula 1 ] & \\ x 0 = W / V * ( T - Tgc ) & Formula ( 1 )\end{matrix}$$

In this formula, W represents a nip width, V represents a conveyance speed, T represents a fixing temperature (or a fixing target temperature), and Tgc represents a gloss control temperature.

Here, the gloss control constant xc and the gloss control temperature Tgc are calculated by an optimization method. For example, the gloss control constant xc and the gloss control temperature Tgc at which the correlation with the glossiness estimation model described below is the highest, that is, the sum of the difference values of the plots is the smallest are calculated.

It is found that in FIG. 4A, the relationship between the combined parameter and the glossiness is weak, but in FIG. 4B, the relationship between the combined parameter and the glossiness is observed.

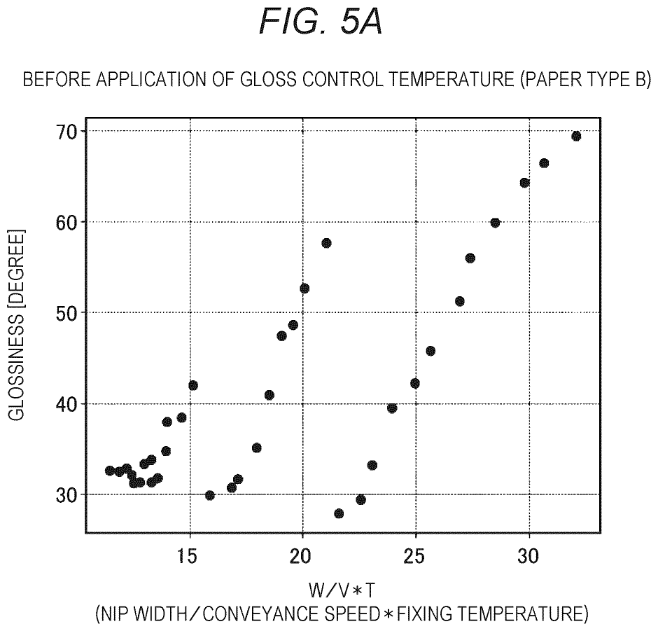

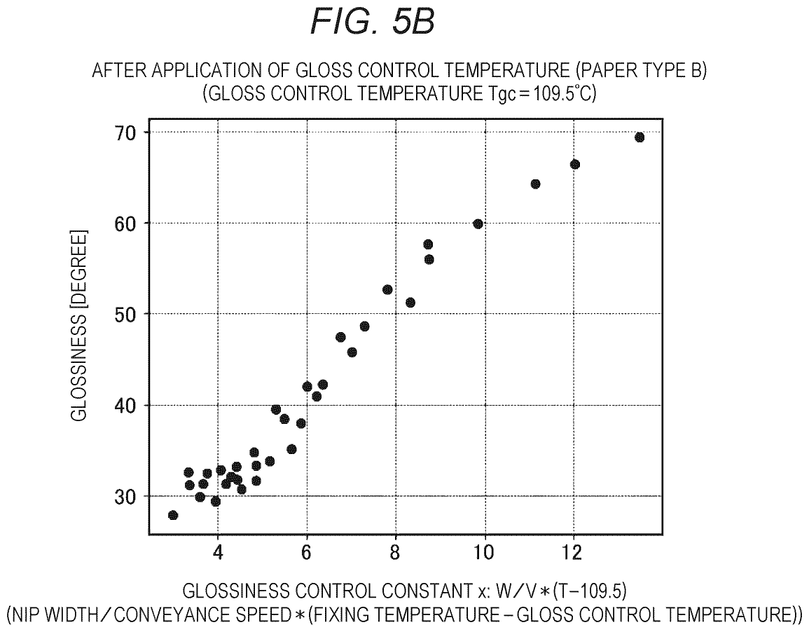

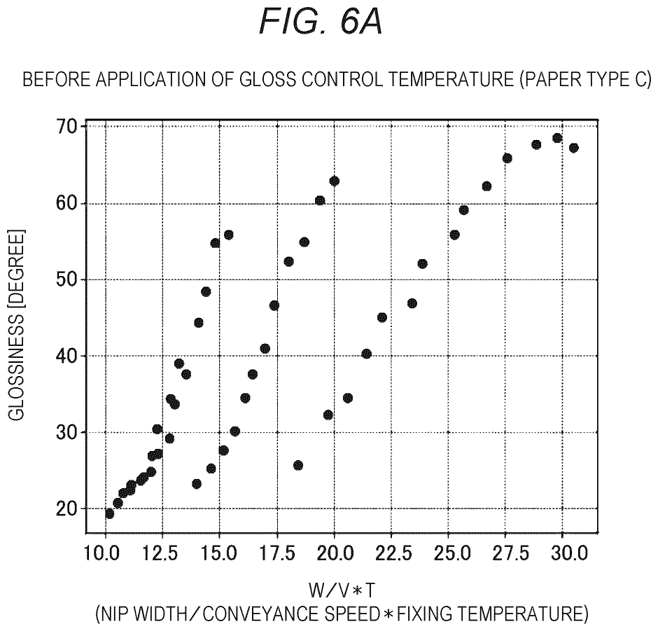

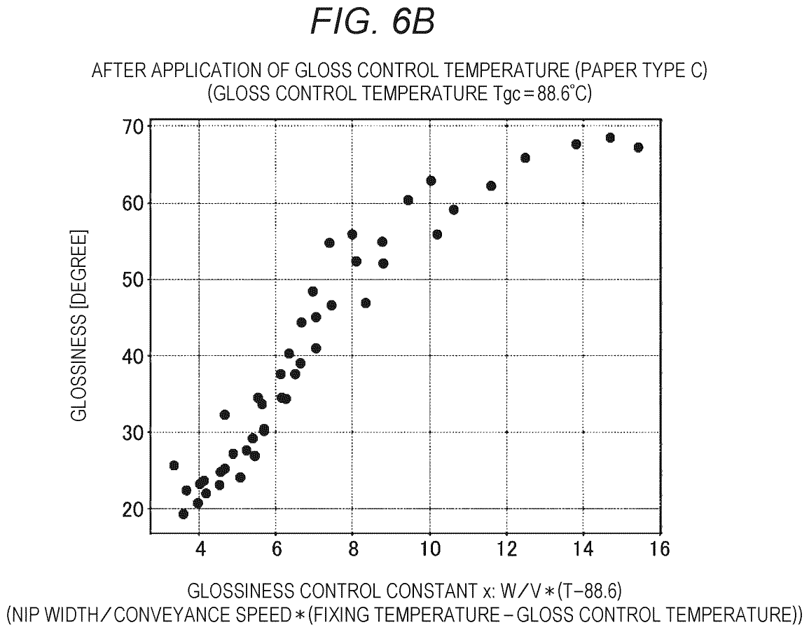

The same tendency is observed in paper type B and paper type C other than paper type A. FIGS. 5A and 6A are scatter plot graphs illustrating the relationship between the combined parameter, which is obtained on the assumptions (1b) to (3b), and the glossiness for paper type B and paper type C, respectively. FIGS. 5B and 6B are scatter plot graphs illustrating the relationship between the combined parameter, which is obtained on the assumptions (1b) to (4b), and the glossiness for paper type B and paper type C, respectively.

### Glossiness Estimation Model

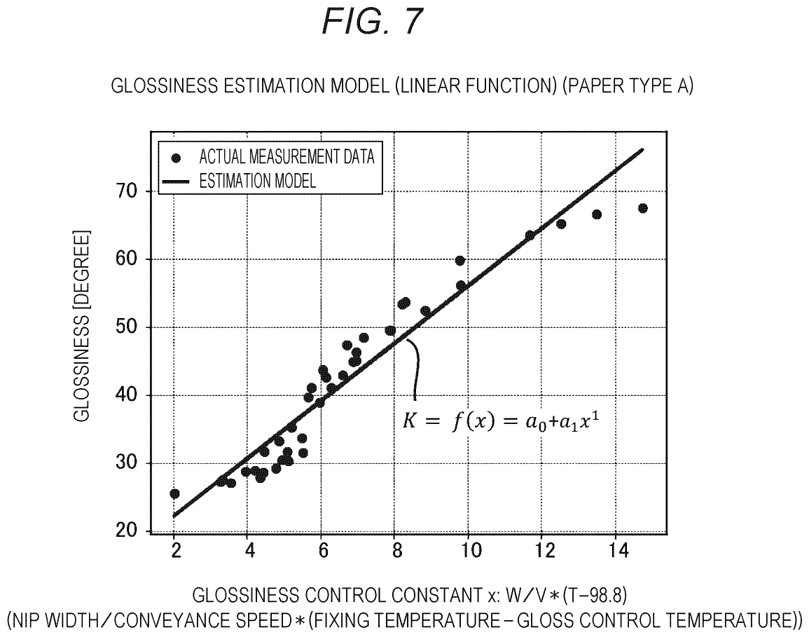

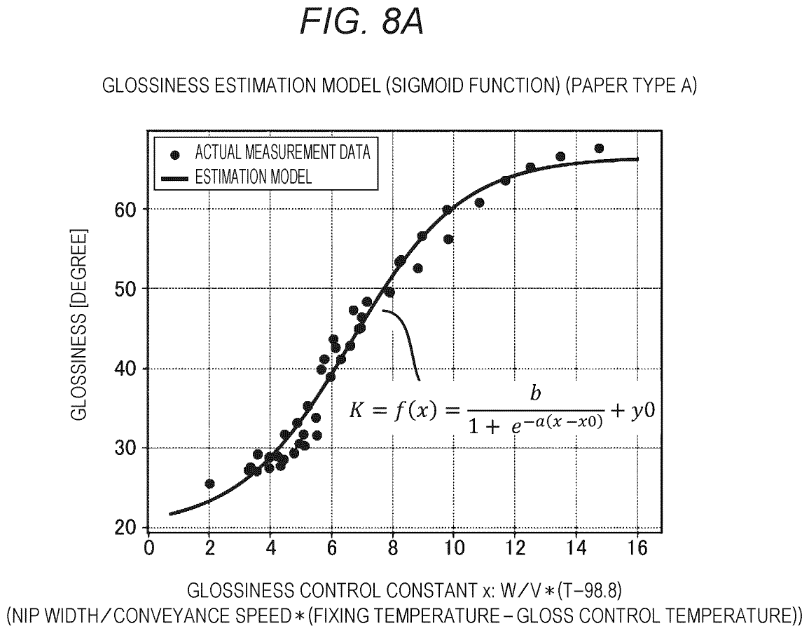

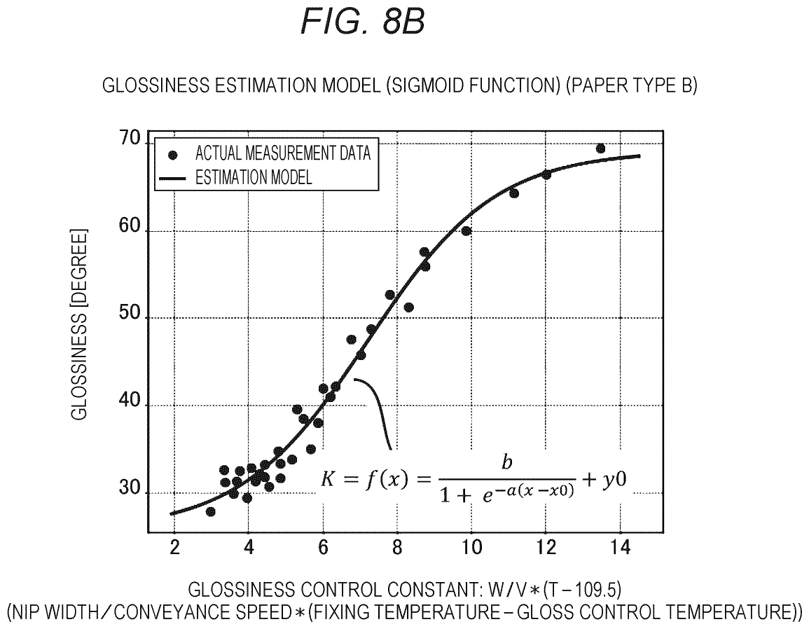

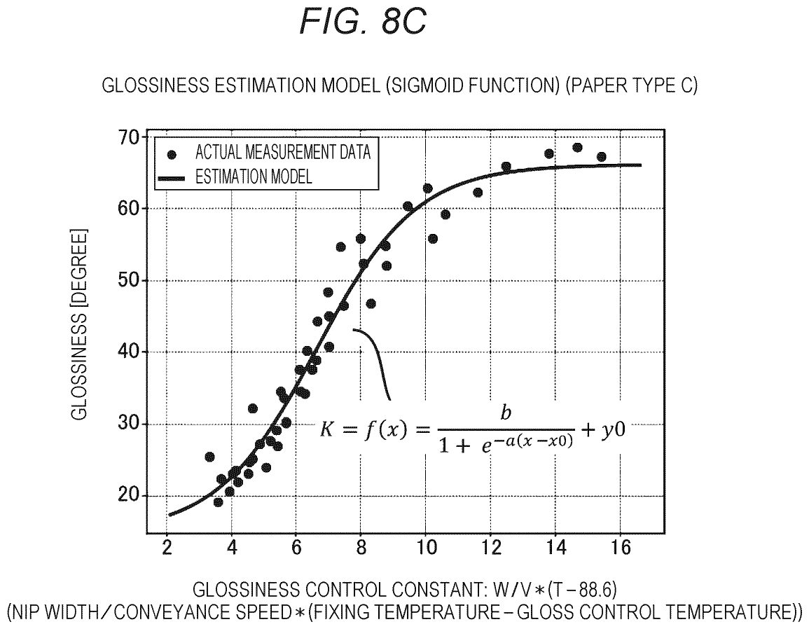

Hereinafter, the glossiness estimation model will be described with reference to FIGS. 7 to 8C. Each plot in FIGS. 7 to 8C corresponds to any one of FIGS. 4B, 5B, and 6B.

FIG. 7 illustrates an example in which a linear function is applied as the glossiness estimation model.

$$\begin{matrix}[ Mathematical Formula 2 ] & \\ K = f ( x ) = {a}_{0} + {\sum }_{i = 1}^{n} {a}_{i} {x}^{i} & Formula ( 2 )\end{matrix}$$

In the linear function illustrated in FIG. 7, data of a₀ to aₙ are obtained from the polynomial model of Formula (2) by a mathematical optimization method.

FIGS. 8A to 8C illustrate an example in which a sigmoidal function is applied as the glossiness estimation model. An equation obtained by applying a sigmoid function and adding a scaling a in the x-axis direction, an x-axis offset x0, a scaling b in the y-axis direction, and a y-axis offset y0 is set as a model equation, and an equation K=f(x) of the glossiness K from the gloss control constant x is set as Formula (3) below.

$$\begin{matrix}[ Mathematical Formula 3 ] & \\ K = f ( x ) = \frac{b}{1 + {e}^{- a ( x - x o )}} + y 0 & Formula ( 3 )\end{matrix}$$

In this formula, a, b, x0, and y0 are obtained from data by a mathematical optimization method. As described above, it can be understood that the correlation with the model is higher when the sigmoid function is used.

In addition, an inverse function used in processing described below will be described. When the glossiness K is given, the inverse model g(K) for obtaining the gloss control constant x is represented by Formula (4) below by transforming the form of y=f(x) so that x becomes a function of y.

$$\begin{matrix}[ Mathematical Formula 4 ] & \\ x = g ( K ) = \frac{- 1}{a} ln \{ \frac{b}{K - y 0} - 1 \} + x 0 & Formula ( 4 )\end{matrix}$$

### Parameter Adjustment Processing

Hereinafter, the parameter adjustment processing executed by the image forming apparatus will be described with reference to FIGS. 9 to 16. FIG. 9 is a flowchart illustrating the parameter adjustment processing.

### Step S01

Upon acceptance of a print job, when the controller 11 determines that printing is to be started (YES), the processing proceeds to step S02.

### Step S02

The controller 11 reads the target glossiness from the storage 12. As a setting example of the target glossiness to be read here, there are the following three processes. Hereinafter, the description will be given in order.
(1a) The glossiness setter 111 receives setting of a relative value of the target glossiness from the user.
(2a) The glossiness setter 111 receives setting of an absolute value of the target glossiness from the user.
(3a) In forming an image for one print job, the glossiness setter 111 sets an initial glossiness as the target glossiness so as to make the glossiness constant in the print job.
   <(1a) Reception of Setting of Relative Value of Target Glossiness from User>

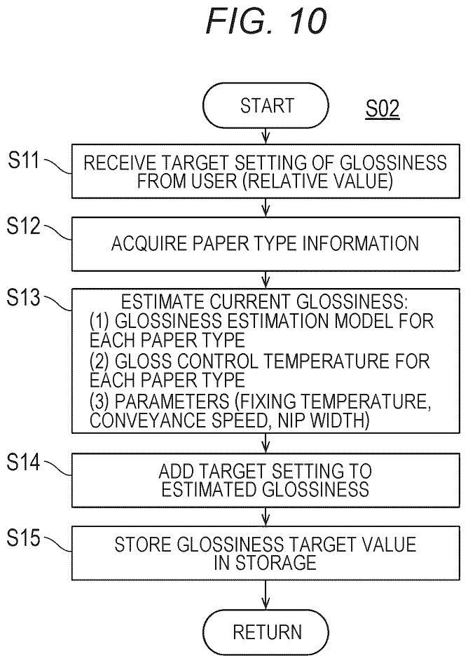

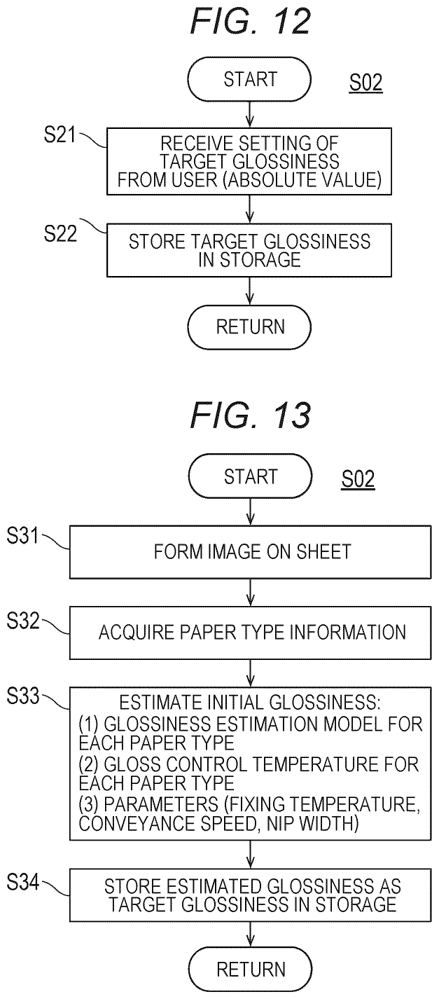

FIG. 10 is a subroutine flowchart illustrating the target glossiness setting processing in step S02. Note that the processing in FIG. 10 may be set at a timing independent of a start of the printing, or may be set immediately before the start of the printing (the same applies to FIG. 12 described below).

### Step S11

The setting of the target glossiness is received from the user through the operation panel 15 or the like. FIG. 11A is an example of a target glossiness setting screen 151 to be displayed on the operation panel 15. Note that this setting screen may be implemented by a print setting application on a terminal apparatus such as a personal computer operated by the user.

On the setting screen 151, the user can make a setting so as to relatively increase or decrease the glossiness by operating a button in a region a1. The user can set a target value of the glossiness in five levels from +2 to −2. Note that as illustrated in FIG. 11A, the current estimated glossiness may be presented in a region a3 for reference. With respect to this glossiness, by selecting “gloss increase: +2”, “gloss increase: +1”, “reset: +0”, “gloss decrease: −1” and “gloss decrease: −2”, the user can change the current glossiness to +10, +5, +0, −5, and −10, respectively. Further, the user can select one of “paper type”, “print job”, and “common in apparatus” as an application range by activating one of radio buttons in an area a2. The default is set on a paper type basis. The target paper type is selected on another screen. In FIG. 11A, paper type A in tray 1 is selected as a target. Furthermore, the application range is selected on a paper type basis. Further, the glossiness is set to “glossiness increase: +1” (target glossiness: +5).

### Step S12

In step S12, the controller 11 acquires paper type information. The paper type information is registered in the storage 12 in association with the sheet feed tray to be used in the print job.

### Step S13

The glossiness setter 111 estimates the current glossiness. In the estimation of the glossiness, the glossiness setter 111 acquires the glossiness estimation model f(x) for each paper type from the storage 12. Then, the glossiness setter 111 calculates the glossiness control constant xc (xc: W/V*(T−Tgc)) of the combined parameter (1b to 4b) from the current parameters (the fixing temperature T, the conveyance speed V, and the nip width W). Then, the glossiness setter 111 substitutes the glossiness control constant xc into the glossiness estimation model to obtain the glossiness. FIG. 11B is a diagram corresponding to FIG. 8A. When the gloss control constant xc is “8”, a glossiness of 50 is obtained by substituting this value into the glossiness estimation model f(x).

### Steps S14 and S15

The glossiness setter adds the target setting (+5) set in step S11 to the estimated glossiness. That is, the target setting of +5 is added to the glossiness of 50 obtained in step S13, so that the glossiness of 55 is obtained. Then, the glossiness after the addition is stored as the target glossiness of 55 in the storage 12 in association with the paper type in the application range. The processing of FIG. 10 thus ends, and the processing returns to step S03 and the subsequent steps of FIG. 9 (RETURN).

<(2a) Reception of Setting of Absolute Value of Target Glossiness from User>

FIG. 12 is a subroutine flowchart illustrating the target glossiness setting processing in step S02 according to another example, and this subroutine flowchart corresponds to the above process (2a).

### Steps S21 and S22

The glossiness setter 111 receives a setting of a target glossiness (absolute value) from the user. For example, the input of the target glossiness is received by the same setting screen as the setting screen 151 of FIG. 11A. In addition, an application range of the target glossiness may be selectable in the same manner. The glossiness setter 111 stores the received target glossiness as a target value in the storage. The processing of FIG. 12 thus ends, and the processing returns to step S03 and the subsequent steps of FIG. 9 (RETURN).

### <(3a) Setting of Initial Glossiness of Print Job as Target Glossiness>

FIG. 13 is a subroutine flowchart illustrating the target glossiness setting processing in step S02 according to another example, and this subroutine flowchart corresponds to the above process (3a). In the example illustrated in FIG. 13, during execution of one print job, the parameters are adjusted so that the initial glossiness is maintained. As described below, the initial glossiness of the print job is set as the target glossiness during the print job.

### Step S31

The controller 11 causes the image former 13 to form an image on a first sheet 90 of the print job. The glossiness (estimated value) upon formation of the image on the first sheet 90 is set as the target glossiness by the following processing.

### Step S32

In step S32, the controller 11 acquires paper type information of the print job to be executed. The paper type information is registered in association with the sheet feed tray.

### Step S33

The glossiness setter 111 estimates the initial glossiness of the print job. For example, the glossiness of the first sheet is estimated. The glossiness setter 111 acquires the glossiness estimation model (f(x)) for each paper type from the storage 12. Then, the glossiness setter 111 calculates the glossiness control constant xc (W/V*(T−Tgc)) from the current parameters (the fixing temperature T, the conveyance speed V, and the nip width W). The glossiness setter 111 substitutes the glossiness control constant xc into the glossiness estimation model to obtain the glossiness.

### Step S34

The glossiness setter 111 stores the obtained estimated glossiness as the target glossiness in the storage 12 in association with the paper type in the application range. The processing of FIG. 13 thus ends, and the processing returns to step S03 and the subsequent steps of FIG. 9 (RETURN).

### Step S03

As illustrated in FIG. 9, the controller 11 acquires the paper type information of the sheet 90 used for printing. Information on the paper type to be used for printing is set in the print job. The paper type information is set in association with the sheet feed tray to be used in the print job. Note that in the examples of FIGS. 10 and 13, the paper type information has already been acquired, and therefore, in that case, the processing here may be omitted.

### Steps S04 to S06

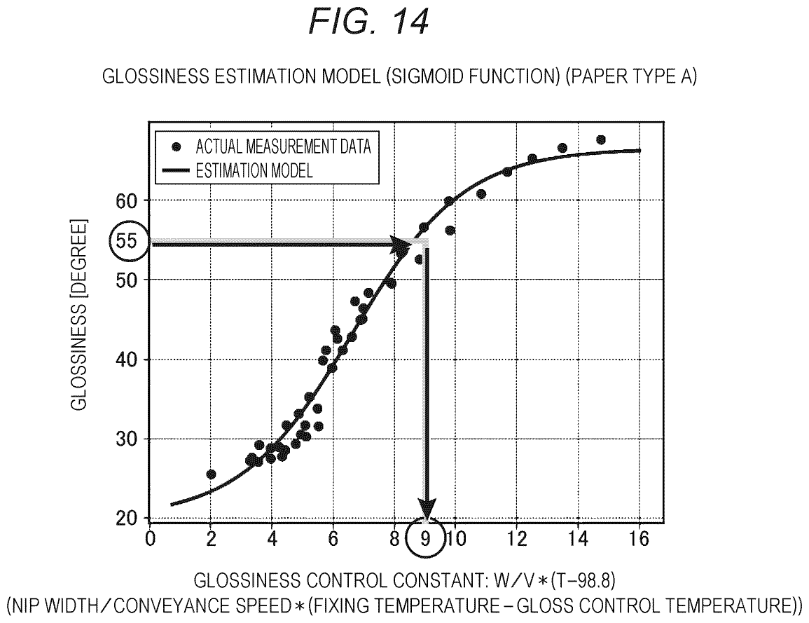

In steps S04 to S06, the parameter adjuster 112 determines the glossiness control constant (xc) based on the acquired target glossiness (=55). The parameter adjuster 112 acquires the glossiness estimation model corresponding to the paper type, and the gloss control temperature Tgc, from the storage 12. The parameter adjuster 112 substitutes the target glossiness acquired in step S02 into the inverse function g(Z) of the glossiness estimation model acquired from the storage to determine the glossiness control constant xc. The inverse function is, for example, the one represented by Formula (3) above. FIG. 14 is a diagram corresponding to FIG. 11B. For example, if the target glossiness is “55” (current glossiness of 50+correction of 5) by the processing of FIG. 10, it is found that the glossiness control constant xc is “9” by substituting “55” into the inverse function g(Z) of the glossiness estimation model.

### Step S07

The parameter adjuster 112 acquires the current parameters. In step S07, the fixing temperature TO, the conveyance speed V0, and the nip width W0 are obtained.

### Step S08

The parameter adjuster 112 adjusts the parameters in order to maintain the gloss. The parameters adjusted in step S08 include at least one of the fixing target temperature, the conveyance speed, and the nip width. In the following, an example of adjusting the fixing target temperature will be described first as a representative, and an example of adjusting the nip width will be described next. Although the description of the conveyance speed is omitted, the conveyance speed can also be adjusted in the same manner.

### Adjustment of Fixing Target Temperature T1

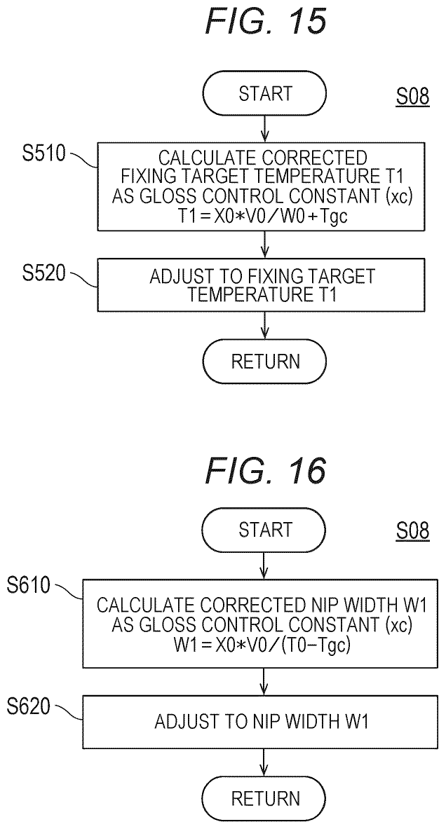

FIG. 15 is a subroutine flowchart illustrating the parameter adjustment processing in step S08.

### Step S510

The parameter adjuster 112 calculates the corrected fixing target temperature T1 which is the gloss control constant xc determined in step S06. The calculation is performed by Formula (5) below obtained by modifying Formula (1) above.

$$\begin{matrix}[ Mathematical Formula 5 ] & \\ T 1 = xc * V 0 / W 0 + Tgc & Formula ( 5 )\end{matrix}$$

### Step S520

The parameter adjuster 112 thereafter changes the fixing target temperature from T0 to T1 to control the temperature of the fixer 136 during image formation. The processing of FIG. 15 thus ends, and the processing returns to step S09 and the subsequent steps of FIG. 9 (RETURN).

### Adjustment of Nip Width W1

FIG. 16 is a subroutine flowchart illustrating the parameter adjustment processing in step S08.

### Step S610

The parameter adjuster 112 calculates the corrected nip width W1 as the gloss control constant xc determined in step S06. The calculation is performed by Formula (6) below obtained by modifying Formula (1) above.

$$\begin{matrix}[ Mathematical Formula 6 ] & \\ W 1 = xc * V 0 / ( T 0 - Tgc ) & Formula ( 6 )\end{matrix}$$

### Step S620

The parameter adjuster 112 changes the nip width of the fixer 136 during image formation from W0 to W1. This change is performed by the controller 11 operating the inter-fixing shaft adjustment mechanism 16. The processing of FIG. 16 thus ends, and the processing returns to step S09 and the subsequent steps of FIG. 9 (RETURN).

### Step S09

In step S09, the image former 13 forms an image on the sheet 90.

### Step S10

When the controller 11 determines that the printing of the entire print job is not completed (NO), the processing returns to step S07 and the subsequent steps are repeated (circled number 20). On the other hand, when the controller 11 determines that the printing of the entire print job is completed (YES), the processing of FIG. 9 ends (END).

As described above, an image forming apparatus according to the present embodiment includes: a fixer that fixes a toner image on a sheet; a glossiness setter that sets a target glossiness; and a parameter adjuster that adjusts at least one parameter selected from a fixing target temperature and a conveyance condition of the sheet in the fixer, using a gloss control temperature so as to achieve a set target glossiness. Thus, a desired glossiness can be maintained by appropriately adjusting the parameters.

### Modification Example 1

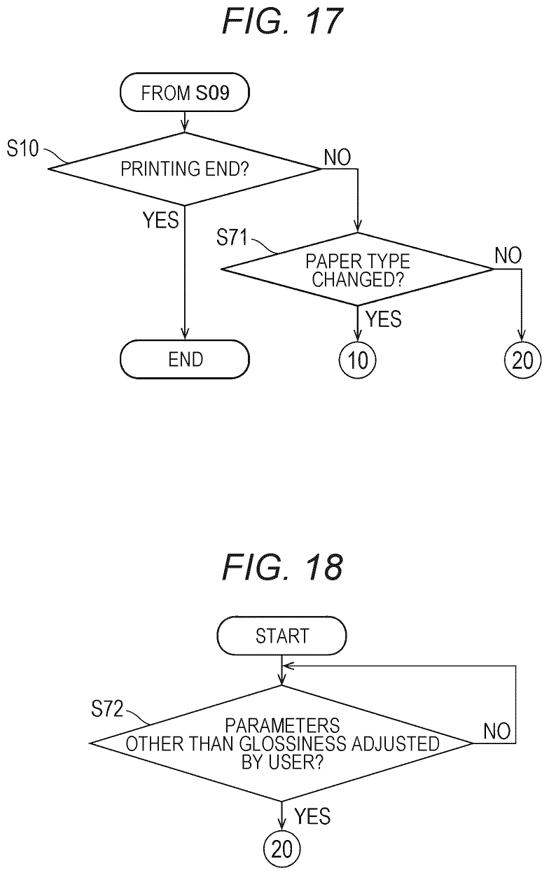

FIG. 17 is a flowchart illustrating processing performed when the paper type is changed in one print job according to Modification Example 1.

### Step S71

When the paper type is changed (YES) during execution of the print job in step S10 (NO), the processing proceeds to step S03 (circled number 10) in FIG. 9, and the paper type information acquisition processing in step S03 and subsequent steps are performed. On the other hand, when the paper type is not changed (NO), processing in step S07 and the subsequent steps (circled number 20) are performed. As described above, when the paper type is changed during a print job, the controller 11 newly determines the glossiness control constant xc in accordance with the paper type information. Then, the controller 11 performs a parameter adjustment for maintaining the glossiness by using the glossiness control constant xc. As the target glossiness after the change of the paper type, when the common target glossiness is set in the print job as in the setting in the area a2 of the setting screen 151, the common target glossiness is used before and after the change of the paper type.

### Modification Example 2

FIG. 18 is a flowchart illustrating processing performed when the user adjusts the parameters according to Modification Example 2.

### Step S81

When the user provides an instruction to adjust the parameters other than the glossiness through the operation panel 15 or the like and adjusts parameters (YES), the processing proceeds to step S07 (circled number 20) in FIG. 9, and the processing in step S07 and the subsequent steps are performed. In this case, the parameters set by the adjustment by the user are fixed, and the remaining parameters are adjusted. For example, when the nip width is adjusted by the adjustment instruction from the user, the parameter of the fixing target temperature or the conveyance speed other than the nip width is adjusted in step S08. In this way, even if the user provides an instruction to adjust the parameters other than the glossiness, the glossiness can be maintained by adjusting the remaining parameters.

Regarding the configuration of the image forming apparatus 1000 described above, the main configuration has been described in describing the features of the above-described embodiment. The present invention is not limited to the above-described configuration and can be variously modified within the scope of the claims. In addition, a configuration included in a general image forming apparatus is not excluded.

For example, FIG. 1 illustrates the configuration in which the image forming apparatus 1000 is connected to the optional sheet feed unit 20; however, the present invention is not limited thereto. The image forming apparatus 1000 may be a single apparatus without these options, or may be connected to another post-processing apparatus that performs post-processing on a sheet on which an image has been formed by the image forming apparatus main body 10.

Further, although the fixing temperature TO is used in the processing of steps S07 and S08, the fixing target temperature Tt may be used instead. In step S07, the fixing target temperature Tt is acquired, and in the calculation of the parameters after the adjustment in step S08 (S510, S610), the current fixing target temperature Tt is used instead of the fixing temperature T0. Thus, in step S510, the next (adjusted) fixing target temperature T1 is calculated. In addition, in a case where a difference between the fixing temperature and the fixing target temperature is small, the fixing target temperature may be used.

Furthermore, the means and method for performing various kinds of processing in the image forming apparatus 1000 according to the above-described embodiment can be implemented by either a dedicated hardware circuit or a programmed computer. The above-described programs may be provided by, for example, a computer-readable recording medium such as a USB memory or a digital versatile disc (DVD)-ROM, or may be provided online via a network such as the Internet. In this case, the programs recorded on the computer-readable recording medium are usually transferred to and stored in a storage such as a hard disk. In addition, the above-described programs may be provided as independent application software or may be incorporated into software of an apparatus as one function of the apparatus.

One or more embodiments of the present invention have been described and illustrated in detail above; however, the disclosed embodiments are merely illustrative and exemplary and are not intended to limit the scope of the present invention. The scope of the present invention should be interpreted by the wording of the accompanying claims.

What is claimed is:

1. An image forming apparatus comprising:
a fixer that fixes a toner image on a sheet; and
a controller that:
sets a target glossiness; and
adjusts at least one parameter selected from a fixing target temperature and a conveyance condition of the sheet in the fixer, using a gloss control temperature, to achieve the target glossiness that has been set.

2. The image forming apparatus according to claim 1, wherein
the controller adjusts the parameter in accordance with a difference between a detected fixing temperature of a roller of the fixer and the gloss control temperature.

3. The image forming apparatus according to claim 1, wherein
the controller adjusts the parameter in accordance with a difference between a current fixing target temperature for controlling a temperature of a roller of the fixer and the gloss control temperature.

4. The image forming apparatus according to claim 1, wherein
the conveyance condition includes parameters of a conveyance speed of the sheet and a nip width in the fixer.

5. The image forming apparatus according to claim 1, wherein
the gloss control temperature is preset for each paper type.

6. The image forming apparatus according to claim 1, wherein
the parameter is adjusted using a glossiness estimation model indicating a relationship between a glossiness and a glossiness control constant, and
the glossiness control constant is defined by:
X=W/V×(T−Tgc) where X represents a gloss control constant, T represents the fixing target temperature, V represents a conveyance speed, W represents a nip width, and Tgc represents the gloss control temperature.

7. The image forming apparatus according to claim 6, wherein
the glossiness estimation model is a sigmoid function.

8. The image forming apparatus according to claim 6, wherein
the glossiness estimation model is set for each paper type.

9. A parameter adjustment method in an image forming apparatus including a fixer that fixes a toner image on a sheet, the parameter adjustment method comprising:
setting a target glossiness; and
adjusting at least one parameter selected from a fixing target temperature and a conveyance condition of the sheet in the fixer, using a gloss control temperature, to achieve the target glossiness that has been set.

10. The parameter adjustment method according to claim 9, wherein
the adjusting includes adjusting the parameter in accordance with a difference between a detected fixing temperature of a roller of the fixer and the gloss control temperature.

11. The parameter adjustment method according to claim 9, wherein
the gloss control temperature is set for each paper type.

12. The parameter adjustment method according to claim 9, wherein
the adjusting includes adjusting the parameter, using a glossiness estimation model indicating a relationship between a glossiness and a glossiness control constant, and
the glossiness control constant is defined by:
X=W/V×(T−Tgc) where X represents a gloss control constant, T represents the fixing target temperature, V represents a conveyance speed, W represents a nip width, and Tgc represents the gloss control temperature.

13. A non-transitory computer-readable recording medium storing a control program for an image forming apparatus including a fixer that fixes a toner image on a sheet, the control program causing the image forming apparatus to execute:
setting a target glossiness; and
adjusting at least one parameter selected from a fixing target temperature and a conveyance condition of the sheet in the fixer, using a gloss control temperature, to achieve the target glossiness that has been set.
